(19) United States
(12) Patent Application Publication
(10) Pub. No.: US 2018/0345468 A1
(43) Pub. Date: Dec. 6, 2018

(54) TOOL AND METHOD OF USE

(71) Applicant: Joseph Andrew Griffin, DeValls Bluff, AR (US)

(72) Inventor: Joseph Andrew Griffin, DeValls Bluff, AR (US)

(21) Appl. No.: 15/610,578

(22) Filed: May 31, 2017

(51) Int. Cl. B25B 27/18; B25B 13/48

(52) U.S. Cl. CPC B25B 27/18; B25B 23/103; B25B 13/48

(57) ABSTRACT

A removal tool has a base separating a first sidewall from a second sidewall. An alignment collar is disposed within an aperture of the first sidewall. A hydraulic cylinder is in communication with the alignment collar. The hydraulic cylinder has an attachment means at a distal end and a ram configured to extend from a proximal end of the hydraulic cylinder, relative to the first sidewall

### CROSS-REFERENCE TO RELATED APPLICATION(S)

Not applicable

### BACKGROUND OF THE INVENTION

### 1. Field of Invention

The present invention relates to the field of tools. More particularly to aircraft specific tooling and pneumatic-operated piston-driving removal tools.

### 2. Description of Related Art

Aircraft require constant maintenance and repair. Unlike other vehicles, the forces and extreme operating conditions experienced by an aircraft result in unique challenges related to both the static and dynamic components of the aircraft.

Arguably the most vital component of the aircraft are the mechanical components relating to the thrust and thrust reverse mechanisms on a jet aircraft. Specifically, the thrust reverser bolts are subject to extremely low temperatures resulting in freezing. Aside from freezing, any other repair to this area of the aircraft requires removal of the thrust reverser bolt.

As an example, U.S. Pat. No. 4,519,561 to Richard H. Timms describes a thrust reverser actuation mechanisms comprising a pair of nested screwjacks commonly driven by a screwjack drive motor. The inner screwjack translates the blocker doors aft and the outer screwjack deploys the blocker doors into the engine jet stream. The screwjacks have different thread pitches so that the blocker doors are translated aft at a faster rate of speed than they are deployed into the engine jet stream.

Actuators and other components of the thrust reverser assembly are generally attached to a construction known in the art as the “birdcage”. When the thrust reverser requires maintenance that would necessitate the thrust reverser bolt to be removed, the birdcage is often damaged as current tools are inadequate to properly be deployed in the space. The current tools inevitably result in more damage beyond the required repair as they negatively impact the birdcage.

In specific aircraft model such as the Cessna 500, Cessna 560, Hawker Beechjet and others implementing the Nordam thrust reverser assembly, such negative impact on surrounding mechanisms during the repair are inevitable. Further, the issue of collateral damage to surrounding components is compounded as the current tools, methods, and techniques may not be adequate to properly remove the thrust reverser bolt.

Based on the foregoing, there is a need in the art a device, system, and method that will allow for proper removal and maintenance of the thrust reverser bolt and other similarly situated components without the resulting collateral damage and extremely increased expense associated therewith.

### SUMMARY OF THE INVENTION

A removal tool has a base separating a first sidewall from a second sidewall. An alignment collar is disposed within an aperture of the first sidewall. A hydraulic cylinder is in communication with the alignment collar. The hydraulic cylinder has an attachment means at a distal end and a ram configured to extend from a proximal end of the hydraulic cylinder, relative to the first sidewall.

In an embodiment, the tool further comprises an aperture extending through the second sidewall, wherein the second sidewall aperture is coaxially aligned with the aperture of the first sidewall.

In an embodiment, the tool further comprises a pressure bolt disposed within the aperture of the second sidewall, wherein the pressure bolt engages the head of the thrust reverser bolt, wherein the pressure bolt has a hollow interior extending therethrough.

In an embodiment, a drill is passed through the hollow interior, and wherein the drill creates a hole in the head of the thrust reverser bolt.

In an embodiment, the ram has a champhored end distal to the hydraulic cylinder, wherein the champhored end is configured to engage the hole.

A method of removing a thrust reverser bolt comprises the steps of positioning a tool over a head of a thrust reverser bolt, the tool having a base separating first sidewall from a second sidewall, wherein the first and second sidewall extend parallel from the base; attaching a hydraulic cylinder to the first sidewall, wherein a hydraulic ram is slidably disposed within the hydraulic cylinder; applying hydraulic pressure to the hydraulic cylinder, wherein a hydraulic pump is attached to the hydraulic cylinder; the ram extending through an aperture within the first sidewall, wherein the ram extends relative to the hydraulic pressure applied; and the ram severing the head of the head.

In an embodiment, the method further comprises the steps of predrilling at least one pilot hole through the head, wherein a drill is passed through an aperture extending through the second sidewall, wherein the dill contacts the head, and wherein the drill creates a hole in the head aligned with a central axis of the aperture of the first sidewall and the aperture of the second sidewall.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the tool, according to an embodiment of the present invention;

FIG. 2 is a perspective view of the tool, according to an embodiment of the present invention; and

FIG. 3 is a perspective view of the tool, according to an embodiment of the present invention;

### DETAILED DESCRIPTION OF PREFERRED EMBODIMENTS

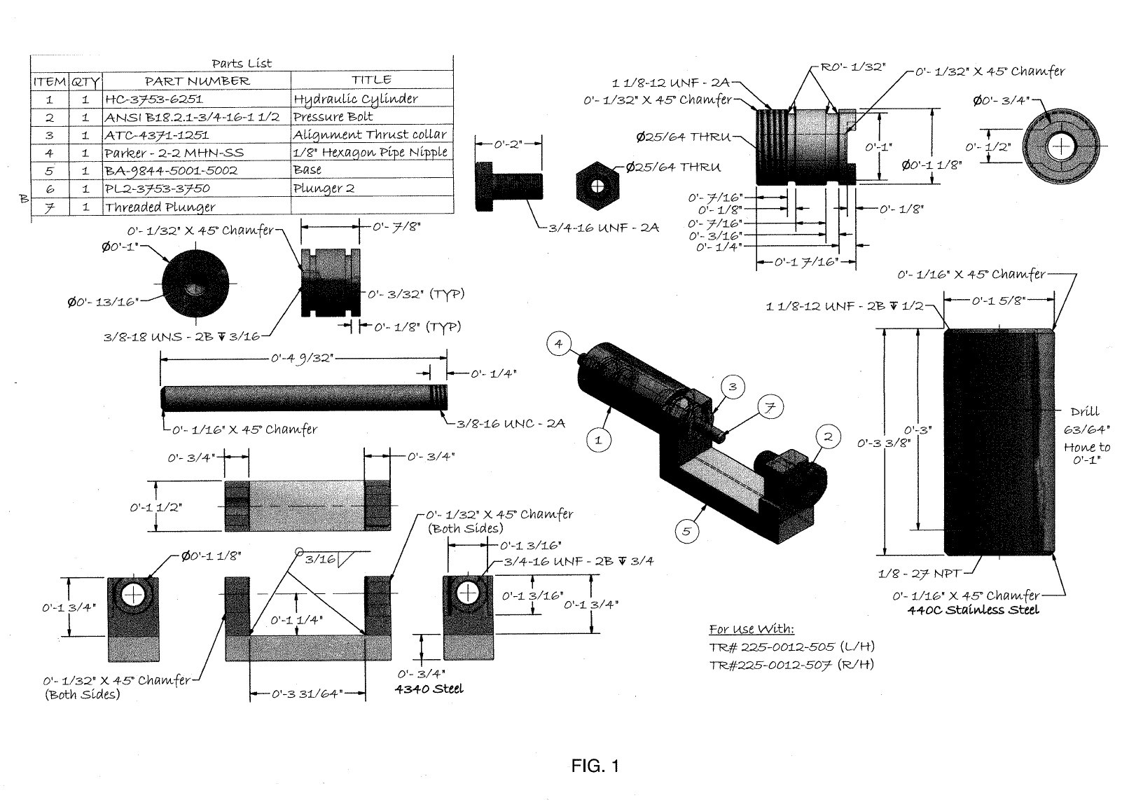

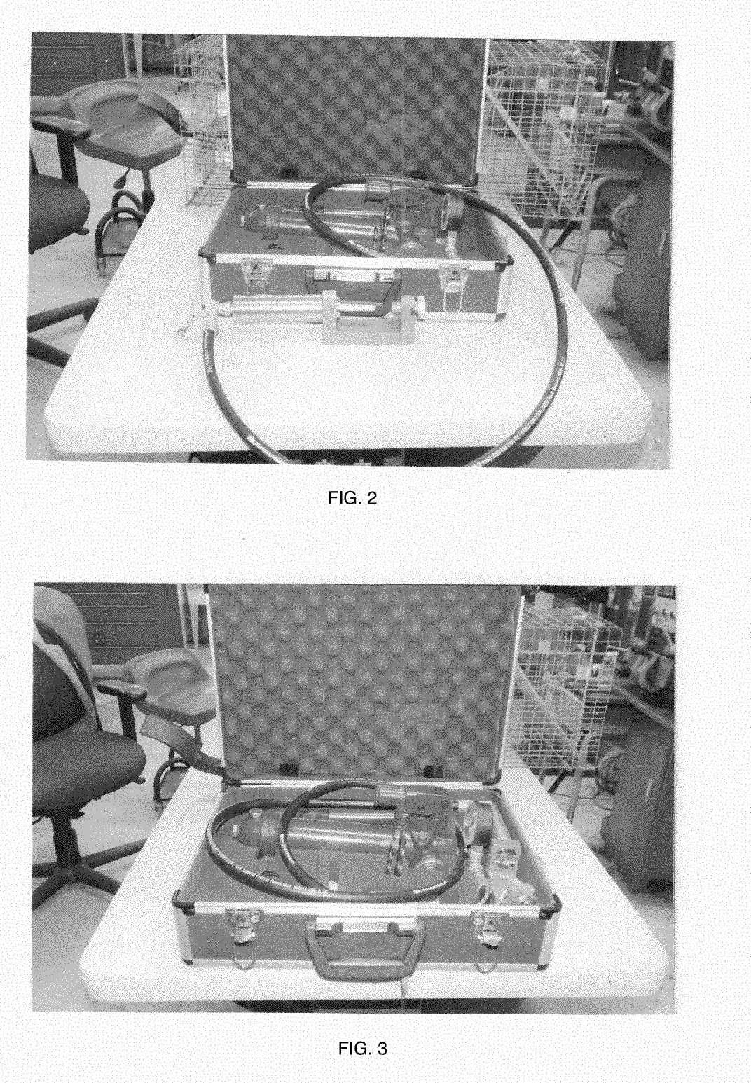

Preferred embodiments of the present invention and their advantages may be understood by referring to FIGS. 1-3, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

A tool has a base extending between at least a first sidewall and a second sidewall. The first and second sidewall extend upward from the base is the same direction such that the first sidewall and the second sidewall are generally parallel to one another. Both the first sidewall and the second sidewall have at least one aperture extending therethrough, respectively. The aperture of the first sidewall is coaxially aligned with the aperture of the second sidewall. A hydraulic cylinder is attached to the first end and is coaxially aligned with the first end aperture. An attachment means is disposed at a distal end of the hydraulic cylinder to receive a connector from a hydraulic pump. An alignment collar is disposed within the aperture of the first sidewall. A ram within the hydraulic cylinder acts as a piston when under pressure to extend through the aperture and alignment collar.

In an embodiment, the ram has a proximal end which enters the space between the first and second sidewall first. The proximal end is champhored around a peripheral edge to facilitate entry into a pilot or alignment hold created in the thrust reverser bolt.

In an embodiment, the hydraulic cylinder engages the alignment collar. For example, the hydraulic cylinder is threaded onto the alignment collar. The alignment collar provides axial alignment for the ram operation to pass through the aperture of the first sidewall.

In an embodiment, the hydraulic cylinder is threadingly engaged to the aperture of the first sidewall. A ram piston is disposed within the hydraulic cylinder. The ram component received the hydraulic pressure generated by a pump. The ram is driven through the first sidewall aperture based on the pressure received.

In an embodiment, one or more bearings are disposed within the aperture of the first sidewall and second sidewalls, respectively, The bearing elements facilitate smooth operation of a drill or ram component being inserted therein during operation.

The distance of the base is predetermined based on the particular application and size of the object being removed, as well as the space provided to work in. In an alternative embodiment, the space between the first and second sidewalls is adjustable such that the base element can be extended or retracted to accommodate varying conditions relating to the removal.

In use, the hydraulic cylinder is removed from the first sidewall. The hydraulic pilot component is then threaded onto the first end and aligned with the head of the thrust reverser bolt. A hole is drilled through the head of the thrust reverser bolt. After the hole is drilled, the hydraulic cylinder is replaced to the first sidewall such that the hydraulic cylinder is on an exterior surface of the first sidewall and the hydraulic ram is positioned to enter the space above the base and between the first end and the second end.

The hydraulic pump is attached to the hydraulic cylinder and the pump generates pressure. The generated pressure is transferred through the hosing to the hydraulic thereby urging the hydraulic ram from the interior of the hydraulic cylinder into the space between the first and second sidewalls. The hydraulic ram engages the head of the thrust reverser bolt where the hole was previously drilled. Pressure is continuously supplied to the ram until the head of the thrust reverser holt has been removed by the ram.

In an embodiment, a pilot hole is predrilled prior to drilling with an increased diameter drill bit. The pilot hole ensures proper alignment of the larger diameter drill bit and precise application of pressure from the subsequent engagement with the hydraulic ram.

In an embodiment, after the bolt is removed, the hydraulic pressure is released and the ram will be positioned where the bolt was previously. To remove, the hydraulic cylinder is removed from the first sidewall. Removal of the hydraulic cylinder at this step will result in the ram maintaining its position between he first and second sidewalls. To remove the ram, s knurled handle is releasably attached to the ram. The knurled surface facilitates manual operation of removal of the ram portion.

In an alternative embodiment, a brush or abrasive component is provided to clean and ensure smooth surfaces of the aperture of the first and second sidewalls are maintained.

In an alternative embodiment, a keeper element is positioned through the aperture of the second sidewall when the tool is not in use to retain the bearing elements disposed within the second sidewall aperture.

While the current description provides examples of removal of a thrust reverser bolt of an aircraft, The application of the piston system may extend to any removal application or hole punch, as appropriate. For example, where cylinders are frozen or fused together where they are installed, the current tool may be positioned according to the desired direction of removal. The hydraulic pressure exponentially increases the power behind the ram compared to convention removal methods.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A removal tool comprising:
a. a base separating a first sidewall from a second sidewall;
b. an alignment collar disposed within an aperture of the first sidewall;
c. a hydraulic cylinder in communication with the alignment collar, the hydraulic cylinder comprising:
i. an attachment means at a distal end and a ram configured to extend from a proximal end of the hydraulic cylinder, relative to the first sidewall.

2. The tool of claim 1, further comprising an aperture extending through the second sidewall, wherein the second sidewall aperture is coaxially aligned with the aperture of the first sidewall.

3. The tool of claim 1, further comprising a pressure bolt disposed within the aperture of the second sidewall, wherein the pressure bolt engages the head of the thrust reverser bolt, wherein the pressure bolt has a hollow interior extending therethrough.

4. The tool of claim 3, wherein a drill is passed through the hollow interior, and wherein the drill creates a hole in the head of the thrust reverser bolt.

5. The tool of claim 4, wherein the ram has a champhored end distal to the hydraulic cylinder, wherein the champhored end is configured to engage the hole.

6. A method of removing a thrust reverser bolt comprising the steps of:
a. positioning a tool over a head of a thrust reverser bolt, the tool having a base separating first sidewall from a second sidewall, wherein the first and second sidewall extend parallel from the base;
b. attaching a hydraulic cylinder to the first sidewall, wherein a hydraulic ram is slidably disposed within the hydraulic cylinder;
c. applying hydraulic pressure to the hydraulic cylinder, wherein a hydraulic pump is attached to the hydraulic cylinder;
d. the ram extending through an aperture within the first sidewall, wherein the ram extends relative to the hydraulic pressure applied; and
e. the ram severing the head of the head.

7. The method of claim 6, further comprising the steps of:
a. predrilling at least one pilot hole through the head, wherein a drill is passed through an aperture extending through the second sidewall, wherein the dill contacts the head, and wherein the drill creates a hole in the head aligned with a central axis of the aperture of the first sidewall and the aperture of the second sidewall.
